(19) United States
(12) Patent Application Publication
(10) Pub. No.: US 2019/0172190 A1
(43) Pub. Date: Jun. 6, 2019

(54) Inspection Apparatus For Inspecting Electronic Components Of Circuit Board On Assembly Line, And Method Thereof

(71) Applicants: Inventec (Pudong) Technology Corporation, Shanghai (CN); Inventec Corporation, Taipei City (TW)

(72) Inventor: Hao Liu, Shanghai (CN)

(21) Appl. No.: 16/009,597

(22) Filed: Jun. 15, 2018

(30) Foreign Application Priority Data
Dec. 6, 2017 (CN) 201711274119.8

(51) Int. Cl. G06T 7/00; G01N 21/956; G01N 21/89; H04N 5/247

(52) U.S. Cl. CPC G06T 7/001; G01N 21/956; G01N 21/8903; G06T 2207/20172; G01N 2021/95638; G06T 2207/30141; H04N 5/247

(57) ABSTRACT

An inspection apparatus for inspecting electronic components of circuit board on assembly line, and a method thereof are disclosed. The inspection apparatus is provided for an assembly line and includes three image capture devices to capture inspection images of parts of a to-be-inspected circuit board respectively, so as to inspect the electronic components of the to-be-inspected circuit board according to the inspection images. As result, the technical effect of inspecting the electronic components of the circuit board on the assembly line can be achieved.

### CROSS-REFERENCE TO RELATED APPLICATION

This application claims the benefit of Chinese Patent Application No. 201711274119.8, filed Dec. 6, 2017.

### BACKGROUND OF THE INVENTION

### 1. Field of the Invention

The present disclosure generally relates to an inspection apparatus, more particularly to an inspection apparatus disposed on an assembly line, and the inspection apparatus comprises three image capture devices to capture inspection images of parts of a to-be-inspected circuit board, respectively, and inspect the electronic components of the circuit board according to the inspection images.

### 2. Description of the Related Art

The assembly line is an industrial production manner, and each production unit of the assembly line only focuses on a certain sectional process, so as to improve work efficiency and output of production; in general, the assembly line is the most efficient way of industrial production. In the production of circuit boards, a circuit board has a large number of electronic components and high complexity, so the assembly line can be used to maximize production efficiency for circuit boards.

In recent years, operators generally inspect the circuit boards produced through the assembly line visually during the process on the assembly line; or, the to-be-inspected circuit board must be moved out of the assembly line to be inspected by the dedicated inspection apparatus. However, the operator's visual inspection for electronic components of the circuit board may result in human misjudgment, and the manner of using the dedicated inspection device to inspect the electronic components must first move the circuit board out of the assembly line, and it causes reduction in production efficiency and extra labor costs.

Therefore, what is needed is to develop an improved technical solution to solve the conventional problem that it is inconvenient to inspect the electronic components of the circuit board on the assembly line.

### SUMMARY OF THE INVENTION

In order to solve the problem that it is inconvenient to inspect electronic components of a circuit board on an assembly line, the present invention is to provide an inspection apparatus for inspecting electronic components of a circuit board on an assembly line, and a method thereof.

According to an embodiment, the present invention provides an inspection apparatus for inspecting electronic components of a circuit board on an assembly line. The inspection apparatus comprises a device chassis, a display device, an internal assembly line, a fixing frame, three fixing plates, three image capture devices and an inspection device. The inspection device comprises a processor and a storage device.

The device chassis includes an inlet of the internal assembly line and an outlet of the internal assembly line. The display device is disposed inside the device chassis, and configured to display an inspection result. The internal assembly line is disposed inside the device chassis, a to-be-inspected circuit board is moved into the device chassis from the inlet of the internal assembly line, and the to-be-inspected circuit board is driven by the internal assembly line, to leave the device chassis through the outlet of the internal assembly line. The fixing frame is disposed inside the device chassis and on the top of the device chassis. Each fixing plate has a first fix end and a second fix end, and is fixed on the fixing frame by its first fix end. The three image capture devices are fixed at the second fix ends of the three fixing plates, respectively, and configured to capture inspection images of parts of the to-be-inspected circuit board according to a movement rate of the internal assembly line.

The inspection device is disposed inside the device chassis, and the storage device is configured to store a plurality of instructions. The processor is configured to load and execute the plurality of instructions to execute following operations: receiving the inspection images of the parts of the to-be-inspected circuit board from the three image capture devices respectively; performing an image correction on the inspection images of the parts of the to-be-inspected circuit board; and inspecting electronic components of the to-be-inspected circuit board according to the corrected inspection images of the parts of the to-be-inspected circuit board, so as to generate the inspection result.

According to an embodiment, the present invention provides an inspection method for inspecting electronic components of a circuit board on an assembly line. The inspection method comprises steps of providing an inspection apparatus comprising a device chassis, a display device, an internal assembly line, a fixing frame, three fixing plates, three image capture devices and an inspection device; providing the device chassis with an inlet of the internal assembly line and an outlet of the internal assembly line; disposing the display device inside the device chassis, wherein the display device is configured to display an inspection result; disposing the internal assembly line disposed inside the device chassis, wherein a to-be-inspected circuit board is moved into the device chassis from the inlet of internal assembly line, and the to-be-inspected circuit board is driven by the internal assembly line to leave the device chassis through the outlet of internal assembly line; disposing the fixing frame inside the device chassis and on the top of the device chassis; fixing the three fixing plates each with a first fix end and a second fix end on the fixing frame by the first fix ends respectively; fixing the three image capture devices at the second fix ends of the three mounting plates respectively, wherein the three image capture devices are configured to capture inspection images of parts of the to-be-inspected circuit board according to a movement rate of the internal assembly line; disposing the inspection device inside the device chassis; receiving, by the inspection device, the inspection images of the parts of the to-be-inspected circuit board from the three image capture devices respectively; performing an image correction, by the inspection device, on the inspection images of the parts of the to-be-inspected circuit board; and inspecting, by the inspection device, the electronic components of the to-be-inspected circuit board according to the corrected inspection images of the parts of the to-be-inspected circuit board, so as to generate the inspection result.

According to above content, the difference between the technology of the present invention and conventional technology is that the inspection apparatus and method of the present invention can inspect the electronic components of the to-be-inspected circuit board, so as to solve the problem of inconvenience in inspection of the electronic components of the circuit board on the assembly line.

The aforementioned technical solution can achieve the technical effect of inspecting the electronic components of the circuit board on the assembly line.

### BRIEF DESCRIPTION OF THE DRAWINGS

The structure, operating principle and effects of the present disclosure will be described in detail by way of various embodiments which are illustrated in the accompanying drawings.

FIG. 1A is a first-view-angle perspective view of an inspection apparatus for inspecting electronic components of a circuit board on an assembly line according to an embodiment of the present invention.

FIG. 1B is a second-view-angle perspective view of the inspection apparatus for inspecting electronic components of the circuit board on the assembly line according to the embodiment of the present invention.

FIG. 1C is a third-view-angle perspective view of the inspection apparatus for inspecting electronic components of the circuit board on the assembly line according to the embodiment of the present invention.

FIG. 2 is a schematic view showing usage status of the inspection apparatus for inspecting electronic components of the circuit board on the assembly line according to the embodiment of the present invention.

FIG. 3 is a schematic view of a to-be-inspected circuit board according to an embodiment of the present invention.

FIGS. 4A to 4C are schematic views of operations of capturing inspection images of the to-be-inspected circuit board according to the embodiment of the present invention.

FIG. 5A is a schematic view of an inspection image according to an embodiment of the present invention.

FIG. 5B is a schematic view of corrected inspection image according to an embodiment of the present invention.

FIG. 6 is a perspective plane view of a light-shielding cover according to an embodiment of the present invention.

FIGS. 7A and 7B are flow charts of an inspection method for inspecting electronic components of a circuit board on an assembly line, according to an embodiment of the present invention.

### DETAILED DESCRIPTION OF THE PREFERRED EMBODIMENTS

The following embodiments of the present disclosure are herein described in detail with reference to the accompanying drawings. These drawings show specific examples of the embodiments of the present disclosure. It is to be understood that these embodiments are exemplary implementations and are not to be construed as limiting the scope of the present disclosure in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be understood that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be understood to imply the inclusion of stated elements but not the exclusion of any other elements.

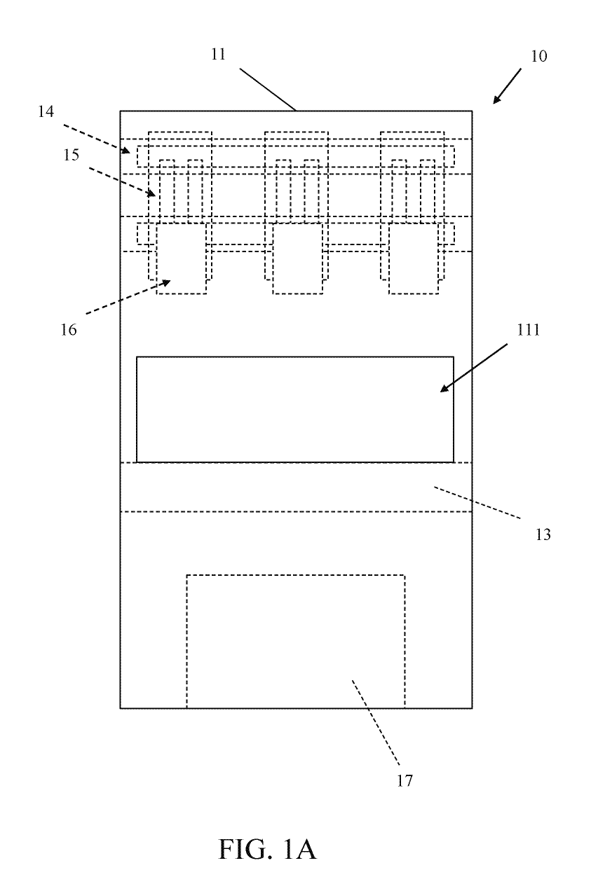

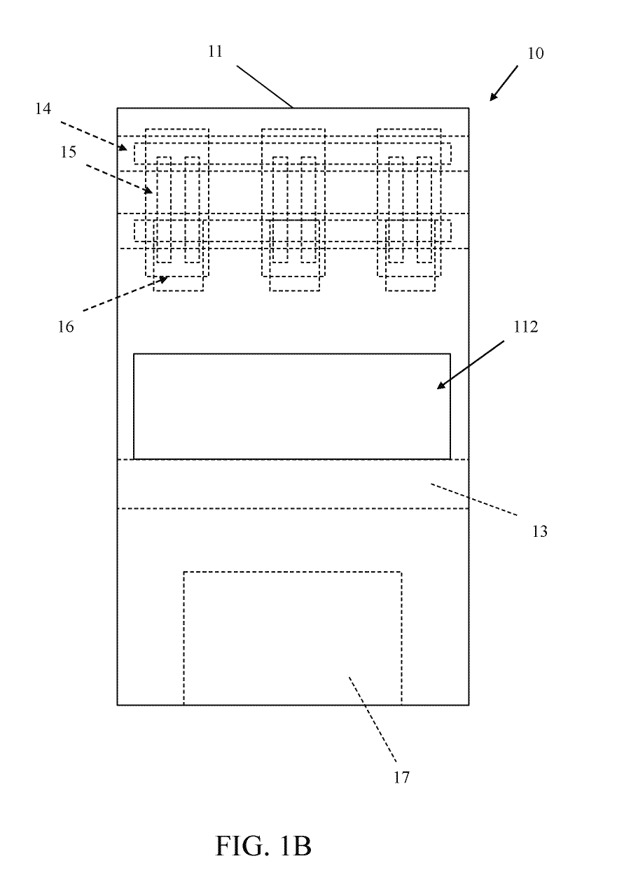

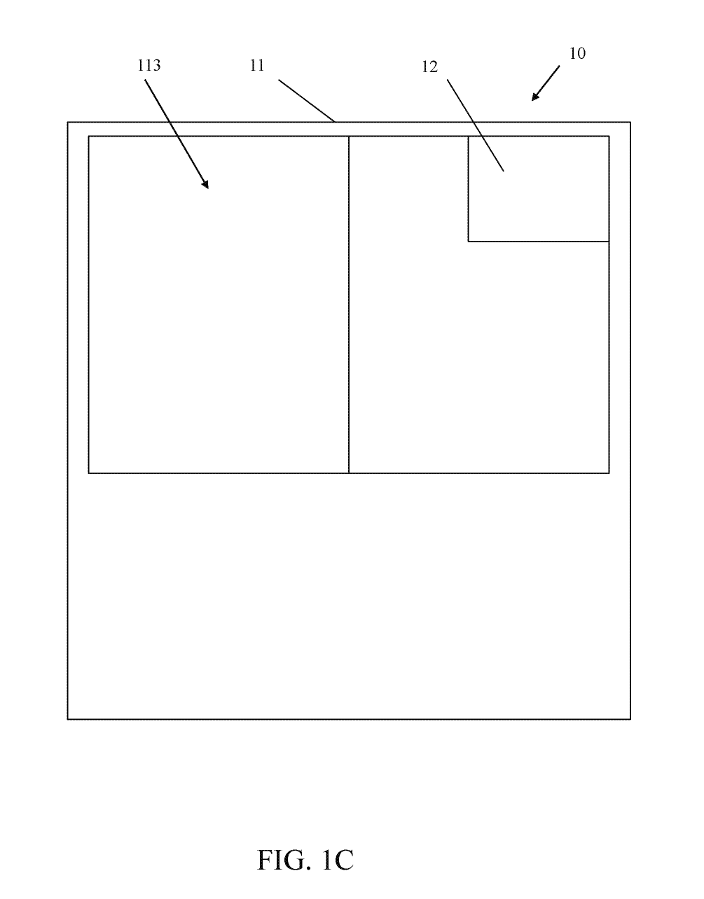

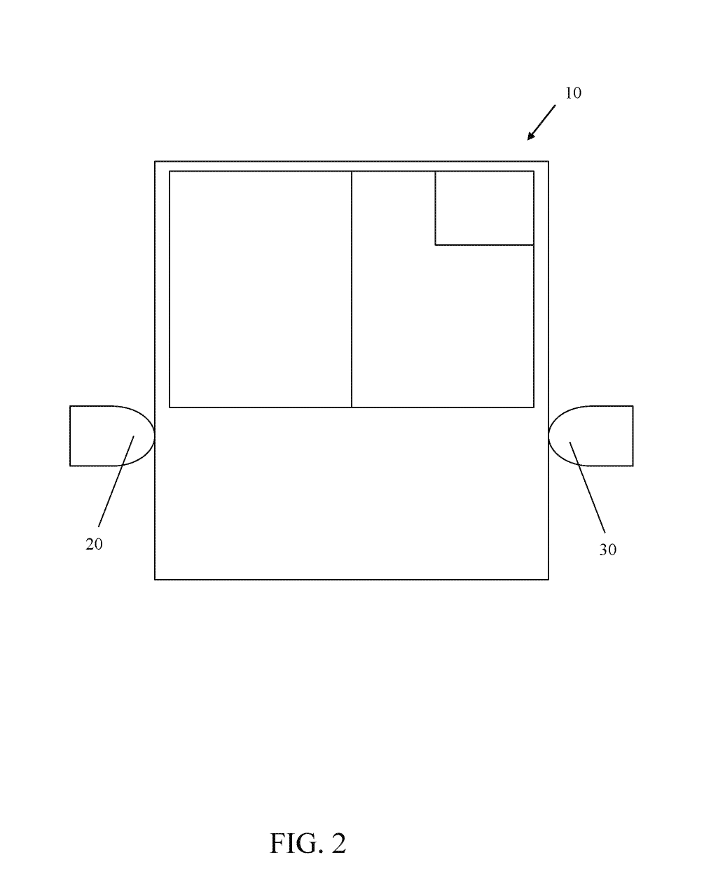

The following illustrate an operation of an inspection apparatus for inspecting electronic components of a circuit board on an assembly line, according to an embodiment of the present invention. Please refer to FIGS. 1A to 1C and FIG. 2. FIG. 1A is a first-view-angle perspective view of an inspection apparatus for inspecting electronic components of a circuit board on an assembly line according to an embodiment of the present invention. FIG. 1B is a second-view-angle perspective view of the inspection apparatus for inspecting electronic components of the circuit board on the assembly line, according to an embodiment of the present invention. FIG. 1C is a third-view-angle perspective view of the inspection apparatus for inspecting electronic components of the circuit board on the assembly line according to an embodiment of the present invention. FIG. 2 is a schematic view showing usage status of the inspection apparatus for inspecting electronic components of the circuit board on the assembly line according to an embodiment of the present invention.

In the embodiment, the inspection apparatus 10 comprises a device chassis 11, a display device 12, an internal assembly line 13, a fixing frame 14, three fixing plates 15, three image capture devices 16 and an inspection device 17.

The inspection apparatus 10 is disposed between a first assembly line 20 and a second assembly line 30. A to-be-inspected circuit board can be driven by the first assembly line 20 to enter the inspection apparatus 10 for inspection. After the inspection apparatus 10 completes the inspection for the to-be-inspected circuit board, the to-be-inspected circuit board is driven by the second assembly line 30 to be distant from the inspection apparatus 10.

The device chassis 11 is provided with an inlet of the internal assembly line 111 and an outlet of the internal assembly line 112. The inlet of the internal assembly line 111 and the outlet of the internal assembly line 112 are disposed opposite to each other. Preferably, the entire device chassis 11 is made by metal material, for example, the metal material can be iron, iron alloy, aluminum alloy, and so on; however, these examples are merely for exemplary illustration, and the application field of the present invention is not limited thereto. It should be noted that a repair door 113 can be disposed on the device chassis 11. Preferably, the repair door 113 can be a sliding door, or a general door which can be opened or closed at left and right sides; however, these examples are merely for exemplary illustration, the application field of the present disclosure is not limited thereto.

The display device 12 is disposed on the device chassis 11, for example, the display device 12 can be hung on the device chassis 11, or, the display device 12 can also be embedded in the device chassis 11; however, these examples are merely for exemplary illustration, and the application field of the present invention is not limited thereto. The display device 12 is configured to display an inspection result generated by the inspection device 17 according to the inspection images of the parts of the to-be-inspected circuit board.

The display device 12 can be disposed on the repair door 113, for example, the display device 12 can be hung on the repair door 113 or embedded in the repair door 113; however, these examples are merely for exemplary illustration, and the application field of the present invention is not limited thereto. The display device 12 is configured to display the inspection result generated by the inspection device 17 according to the inspection images of the parts of the to-be-inspected circuit board.

When the inspection result displayed on the display device 12 indicates that the to-be-inspected circuit board does not pass the inspection, inspection personnel can open the repair door 113 of the device chassis 11 to take the circuit board, which is being inspected, out of the device chassis 11, and then review this circuit board.

The internal assembly line 13 is disposed inside the device chassis 11. When the to-be-inspected circuit board is driven by the first assembly line 20 to enter the device chassis 11 through the inlet of the internal assembly line 111 of the inspection apparatus 10, the internal assembly line 13 can move the to-be-inspected circuit board inside the device chassis 11. The to-be-inspected circuit board can be driven by the internal assembly line 13 to leave the device chassis 11 through the outlet of the internal assembly line 112 of the inspection apparatus 10, and to-be-inspected circuit board can be then driven by the second assembly line 30 to be distant from the device chassis 11.

It should be noted that movement rates of the to-be-inspected circuit board on the internal assembly line 13, the first assembly line 20 and the second assembly line 30 can be the same, or the movement rate of the to-be-inspected circuit board on the first assembly line 20 is lower than that of the to-be-inspected circuit board on the internal assembly line 13 and the second assembly line 30; however, these examples are merely for exemplary illustration, and the application field of the present invention is not limited thereto.

The fixing frame 14 is disposed inside the device chassis 11 and on the top of the device chassis 11, and configured to fix the three fixing plates 15. Each fixing plate 15 has a first fix end and a second fix end, and can be fixed on the fixing frame 14 by its first fix end. Preferably, the first fix end of each fixing plate 15 can be fixed on the fixing frame 14 by a screwing manner. Preferably, the three fixing plates 15 are disposed on the fixing frame 14 uniformly. The fixing frame 14 can be made by metal material, for example, the metal material can be iron, iron alloy, aluminum alloy, and so on; however, these examples are merely for exemplary illustration, and the application field of the present invention is not limited thereto.

The three image capture devices 16 are fixed at the second fix ends of the three mounting plates 15 respectively. Preferably, each image capture device 16 can be fixed on the fixing plate 15 by the screwing manner. The three fixing plates 15 are fixed on the fixing frame 14, so that the three image capture devices 16 can be fixed on the fixing frame 14 by the three fixing plates 15 respectively. The three fixing plates 15 are fixed on the fixing frame 14 uniformly, so the three image capture devices 16 can also be fixed on the fixing frame 14 uniformly respectively. The three image capture devices 16 are configured to capture inspection images of parts of the to-be-inspected circuit board according to a movement rate of the internal assembly line 13.

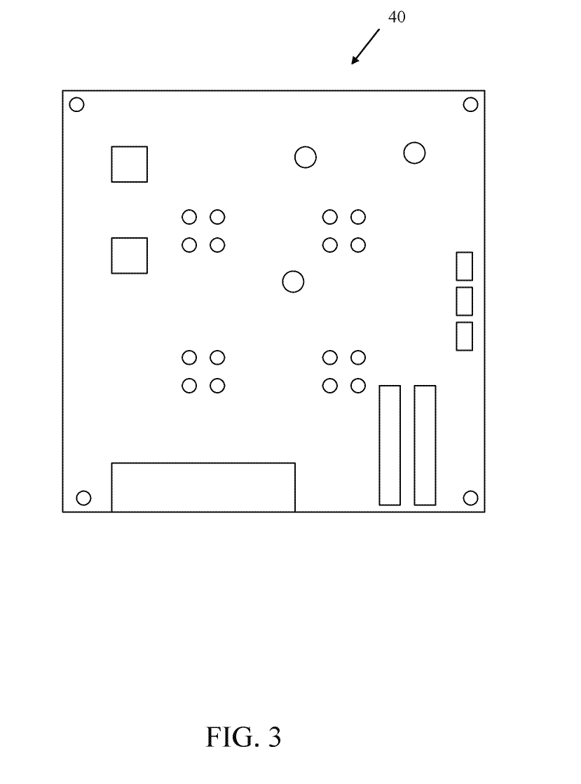

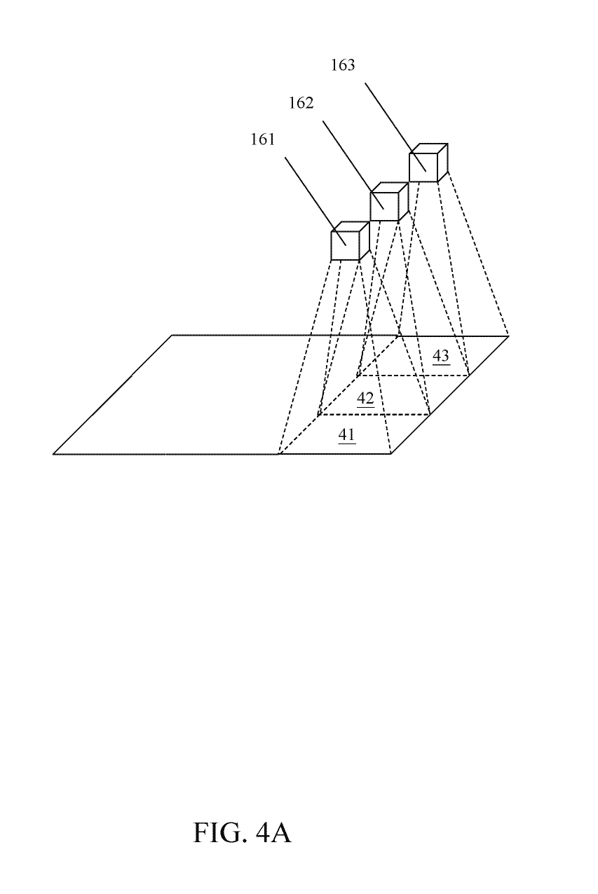

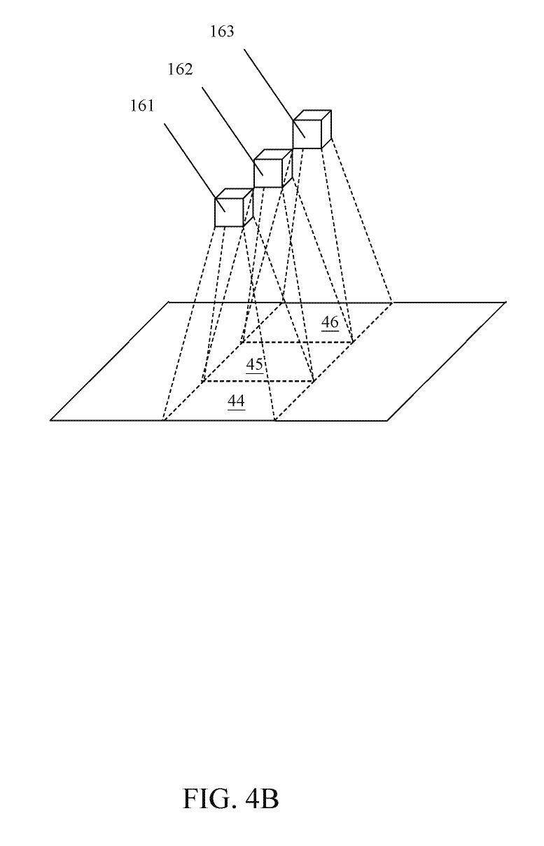

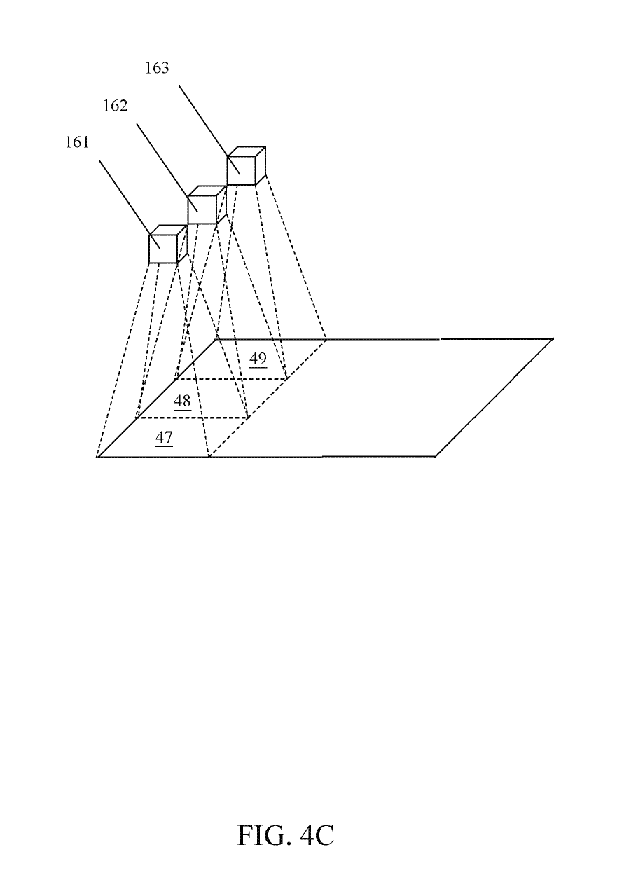

Please refer to FIGS. 3, and 4A to 4C. FIG. 3 is a schematic view of a to-be-inspected circuit board. FIGS. 4A to 4C are schematic views of operations of capturing inspection images of the to-be-inspected circuit board according to an embodiment of the present invention.

The moving speed of the internal assembly line 13 is fixed, so the time point at which the image capture devices 16 captures the inspection images of the parts of the to-be-inspected circuit board 40 can be computed in advance. As shown in FIG. 4A, the image of a first part 41 of the to-be-inspected circuit board 40 captured by the first image capture device 161 is a first inspection image, the image of a second part 42 of the to-be-inspected circuit board 40 captured by the second image capture device 162 is a second inspection image, and the image of a third part 43 of the to-be-inspected circuit board 40 captured by the third image capture device 163 is a third inspection image. The first image capture device 161, the second image capture device 162 and the third image capture device 163 capture the first inspection image, the second inspection image and the third inspection image at the same time.

As shown in FIG. 4B, after a certain movement time (such as, one second, two seconds, or five seconds; and, these examples are merely for exemplary illustration, the application field of the present invention is not limited thereto), the image of a fourth part 44 of the to-be-inspected circuit board 40 captured by the first image capture device 161 is a fourth inspection image, the image of a fifth part 45 of the to-be-inspected circuit board 40 captured by the second image capture device 162 is a fifth inspection image, and the image of a sixth part 46 of the to-be-inspected circuit board 40 captured by the third image capture device 163 is a sixth inspection image. The first image capture device 161, the second image capture device 162 and the third image capture device 163 capture the fourth inspection image, the fifth inspection image and the sixth inspection image at the same time.

As shown in FIG. 4C, after a certain movement time again, the image of a seventh part 47 of the to-be-inspected circuit board 40 captured by the first image capture device 161 is a seventh inspection image, the image of an eighth part 48 of the to-be-inspected circuit board 40 captured by the second image capture device 162 is an eighth inspection image, and the image of a ninth part 49 of the to-be-inspected circuit board 40 captured by the third image capture device 163 is a ninth inspection image. The first image capture device 161, the second image capture device 162 and the third image capture device 163 capture the seventh inspection image, the eighth inspection image and the ninth inspection image at the same time.

Because of large size of the to-be-inspected circuit board 40, in this embodiment, the first image capture device 161, the second image capture device 162 and the third image capture device 163 are used to capture the inspection images of the parts of the to-be-inspected circuit board 40 respectively. In other embodiment, for the to-be-inspected circuit board 40 with different size, only two of the first image capture device 161, second image capture device 162 and third image capture device 163 can be used to capture the inspection images of the parts of the to-be-inspected circuit board 40; or, in other embodiment, for the to-be-inspected circuit board 40 with different size, only one of the first image capture device 161, the second image capture device 162 and the third image capture device 163 is used to capture the inspection images of the parts of the to-be-inspected circuit board 40. Preferably, the number of the image capture device 16 meets the request that the inspection images, captured at the same time, cover one of dimensions of the to-be-inspected circuit board 40.

In the embodiment, the first to ninth inspection images captured by the first image capture device 161, the second image capture device 162 and the third image capture device 163 are not overlapped with each other respectively, and the first to ninth inspection images can be combined to display the complete to-be-inspected circuit board 40.

In other embodiment, the first to ninth inspection images captured by the first image capture device 161, the second image capture device 162 and third image capture device 163 can be partially overlapped with each other respectively; and, the overlapping parts between the first inspection image to ninth inspection image can be kept or removed respectively, so as to combine the first to ninth inspection images to display the complete to-be-inspected circuit board 40.

The inspection device 17 is disposed inside the device chassis 11, and can comprise a processor and a storage device. The storage device is configured to store a plurality of instructions, and the processor is configured to load and execute the plurality of instructions to execute following operations.

The processor of the inspection device 17 can receive the inspection images of the parts of the to-be-inspected circuit board 40 from the three image capture devices 16 respectively by a wired transmission manner (such as a transmission line, a coaxial cable, and so on; however, these examples are merely for exemplary illustration, and the application field of the present invention is not limited thereto) or a wireless transmission manner (such as Wi-Fi, Bluetooth, and so on; however, these examples are merely for exemplary illustration, and the application field of the present disclosure is not limited thereto).

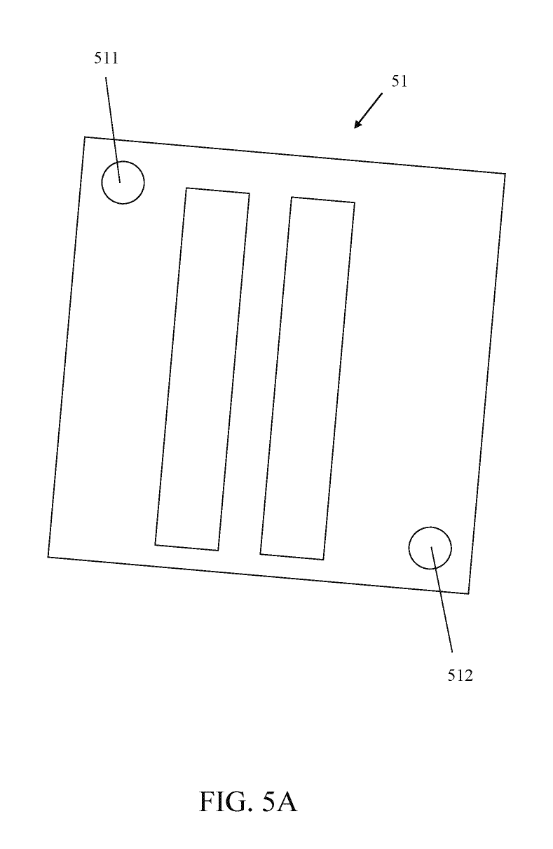

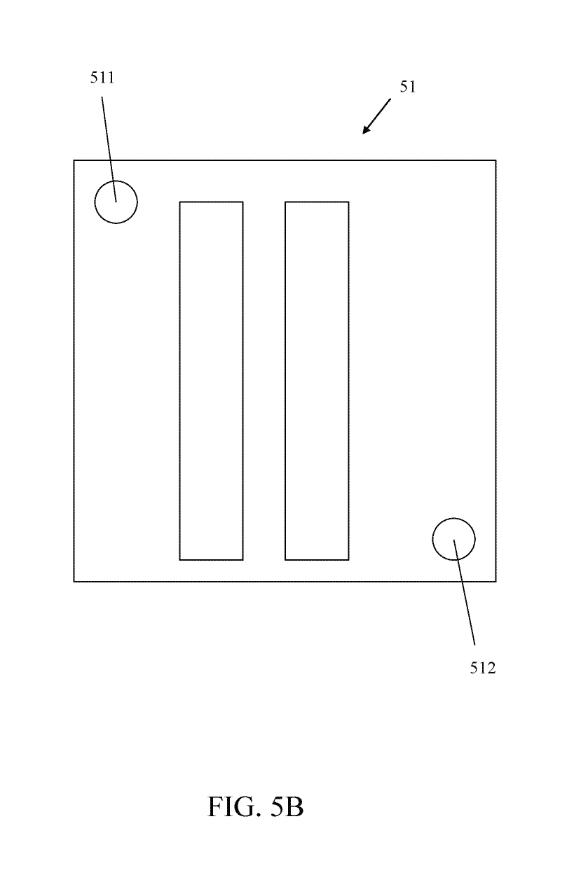

Please refer to FIGS. 5A and 5B. FIG. 5A is a schematic view of an inspection image according to an embodiment of the present invention. FIG. 5B is a schematic view of a corrected inspection image according to an embodiment of the present invention.

After the processor of the inspection device 17 receives the inspection image 51 (as shown in FIG. 5A) of one part of the to-be-inspected circuit board 40 from the image capture device 16, the processor of the inspection device 17 can perform an image correction on the inspection image 51 of the part of the to-be-inspected circuit board. The processor of the inspection device 17 can recognize a first correction point 511 and a second correction point 512 shown in the inspection image 51, and then compare the first correction point and the second correction point of the corrected image with the first correction point 511 and the second correction point 512 of the inspection image 51, so as to compute a correction formula, and then perform image translation and image rotation on the inspection image 51 according to the correction formula. FIG. 5B shows the corrected inspection image 51.

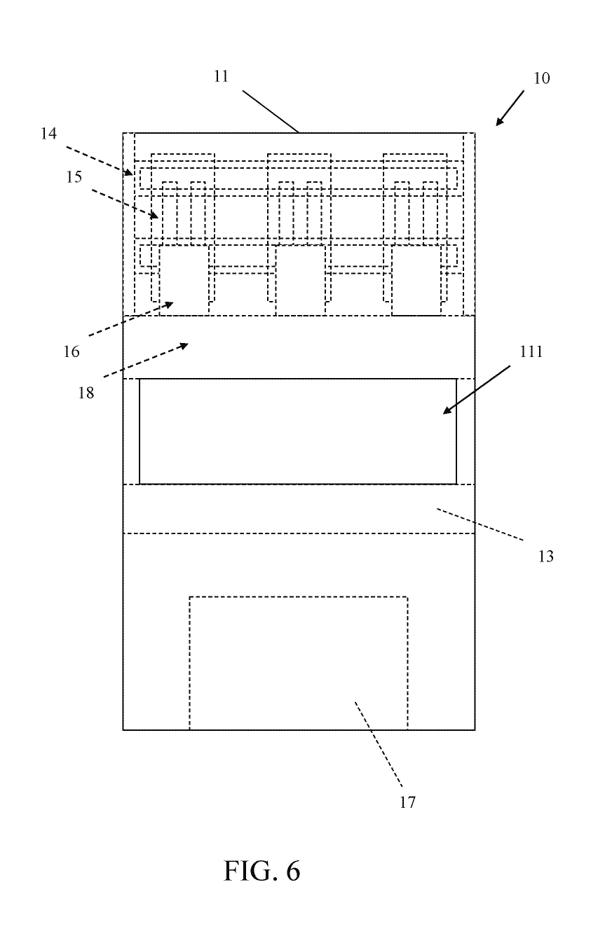

Please refer to FIG. 6, which is a perspective plane view of a light-shielding cover according to an embodiment of the present invention.

In the embodiment, the inspection apparatus 10 can comprise a light-shielding cover 18 hung inside the device chassis 11 and on the top the device chassis 11. Preferably, at least one lighting module can be disposed inside the light-shielding cover 18, and configured to light the to-be-inspected circuit board, for increasing illuminance of the inspection images of the parts of the to-be-inspected circuit board captured by the three image capture devices 16, for providing clear inspection images, so that the inspection device 17 can inspect the electronic components of the to-be-inspected circuit board according to the clear inspection images, thereby providing more accurate inspection result.

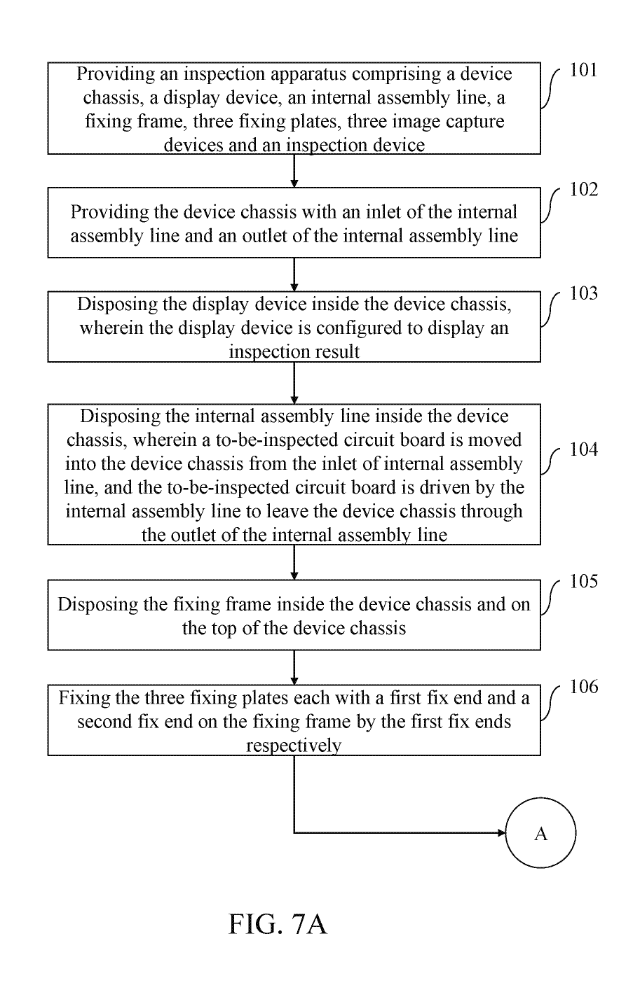

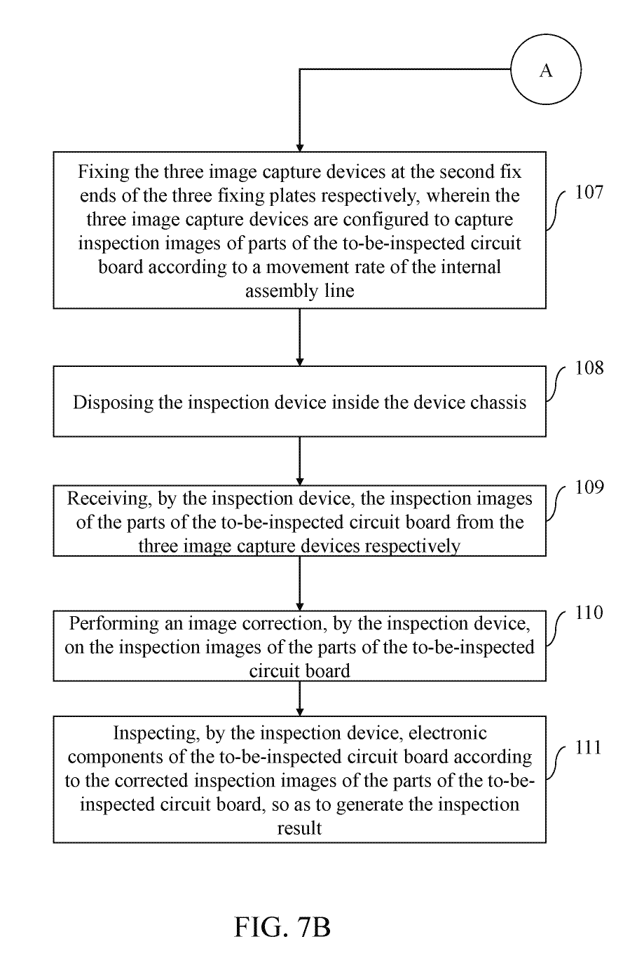

Please refer to FIGS. 7A and 7B. FIGS. 7A and 7B are flow charts of an inspection method for inspecting electronic components of a circuit board on an assembly line according to an embodiment of the present invention.

First, in the step 101, an inspection apparatus comprising a device chassis, a display device, an internal assembly line, a fixing frame, three fixing plates, three image capture devices, and an inspection device, is provided. Next, in the step 102, the device chassis is provided with an inlet of the internal assembly line and an outlet of the internal assembly line. Next, in the step 103, the display device is disposed on the device chassis, wherein the display device is configured to display an inspection result. In the step 104, the internal assembly line is disposed inside the device chassis, wherein a to-be-inspected circuit board can be moved into the device chassis from the inlet of the internal assembly line, and the to-be-inspected circuit board can be driven by the internal assembly line to leave the device chassis through the outlet of the internal assembly line. In the step 105, the fixing frame is disposed inside the device chassis and on the top of the device chassis. In the step 106, the three fixing plates each with a first fix end and a second fix end are fixed on the fixing frame by the fir fix ends respectively. In the step 107, the three image capture devices are fixed at the second fix ends of the three fixing plates respectively, and configured to capture the inspection images of parts of the to-be-inspected circuit board according to a movement rate of the internal assembly line. In the step 108, the inspection device is disposed inside the device chassis. Next, in the step 109, the inspection device receives the inspection images of the parts of the to-be-inspected circuit board from the three image capture devices respectively. In the step 110, the inspection device performs an image correction on the inspection images of the parts of the to-be-inspected circuit board. In the step 111, the inspection device inspects electronic components of the to-be-inspected circuit board according to the corrected inspection images of the parts of the to-be-inspected circuit board, so as to generate the inspection result.

In summary, the difference between the technology of the present invention and the conventional technology is that the apparatus and the method of the present invention is able to inspect the electronic components of the to-be-inspected circuit board, so as to solve the problem of inconvenience in inspection of the electronic components of the circuit board on the assembly line.

The technical solution of the present invention can solve the conventional problem that it is inconvenient to inspect the electronic components of the circuit board on the assembly line, so as to achieve the technical effect of inspecting the electronic component of the circuit board on the assembly line.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An inspection apparatus for inspecting electronic components of circuit board on assembly line, comprising:
a device chassis comprising an inlet of an internal assembly line and an outlet of the internal assembly line;
a display device disposed inside the device chassis and configured to display an inspection result;
the internal assembly line disposed inside the device chassis, wherein a to-be-inspected circuit board is moved into the device chassis from the inlet of the internal assembly line, and the to-be-inspected circuit board is driven by the internal assembly line to leave the device chassis through the outlet of the internal assembly line;
a fixing frame disposed inside the device chassis and on the top of the device chassis;
three fixing plates, each of the three fixing plates comprising a first fix end and a second fix end, and fixed on the fixing frame by the first fix ends;
three image capture devices fixed at the second fix ends of the three fixing plates respectively, wherein each of the three image capture devices is configured to capture an inspection image of a part of the to-be-inspected circuit board according to a movement rate of the internal assembly line; and
an inspection device disposed inside the device chassis, and comprising:
a storage device configured to store a plurality of instructions; and
a processor configured to load and execute the plurality of instructions to execute following operations:
receiving the inspection images of the parts of the to-be-inspected circuit board from the three image capture devices, respectively;
performing image correction on the inspection images of the parts of the to-be-inspected circuit board; and
inspecting electronic components of the to-be-inspected circuit board according to the corrected inspection images of the parts of the to-be-inspected circuit board, so as to generate the inspection result.

2. The inspection apparatus according to claim 1, wherein the inspection apparatus is disposed between a first assembly line and a second assembly line, the to-be-inspected circuit board is driven by the first assembly line, to enter the inlet of internal assembly line, and the to-be-inspected circuit board is driven by the second assembly line to be distant from the outlet of internal assembly line.

3. The inspection apparatus according to claim 1, further comprising:
a light-shielding cover hung at the top of the device chassis by an extension rod, and configured to increase illuminance of the inspection images of the parts of the to-be-inspected circuit board captured by the three image capture devices.

4. The inspection apparatus according to claim 1, wherein the inspection images, captured by the three image capture devices at the same time, cover one of dimensions of the to-be-inspected circuit board.

5. The inspection apparatus according to claim 1, wherein the three fixing plates are fixed on the fixing frame uniformly.

6. A inspection method for inspecting electronic components of circuit board on assembly line, comprising:
providing an inspection apparatus comprising a device chassis, a display device, an internal assembly line, a fixing frame, three fixing plates, three image capture devices and an inspection device;
providing the device chassis with an inlet of the internal assembly line and an outlet of the internal assembly line;
disposing the display device inside the device chassis, wherein the display device is configured to display an inspection result;
disposing the internal assembly line disposed inside the device chassis, wherein a to-be-inspected circuit board is moved into the device chassis from the inlet of internal assembly line, and the to-be-inspected circuit board is driven by the internal assembly line to leave the device chassis through the outlet of internal assembly line;
disposing the fixing frame inside the device chassis and on the top of the device chassis;
fixing the three fixing plates each with a first fix end and a second fix end on the fixing frame by the first fix ends respectively;
fixing the three image capture devices at the second fix ends of the three fixing plates respectively, wherein the three image capture devices are configured to capture inspection images of parts of the to-be-inspected circuit board according to a movement rate of the internal assembly line;
disposing the inspection device inside the device chassis;
receiving, by the inspection device, the inspection images of the parts of the to-be-inspected circuit board from the three image capture devices respectively;
performing an image correction, by the inspection device, on the inspection images of the parts of the to-be-inspected circuit board; and
inspecting, by the inspection device, electronic components of the to-be-inspected circuit board according to the corrected inspection images of the parts of the to-be-inspected circuit board, so as to generate the inspection result.

7. The inspection method according to claim 6, wherein the inspection apparatus is disposed between a first assembly line and a second assembly line, and the to-be-inspected circuit board is driven by the first assembly line to enter the inlet of the internal assembly line, and the to-be-inspected circuit board is driven by the second assembly line to be distant from the outlet of the internal assembly line.

8. The inspection method according to claim 6, wherein the inspection apparatus comprises a light-shielding cover hung at the top of the device chassis by an extension rod, and configured to increase illuminance of the inspection images of the parts of the to-be-inspected circuit board captured by the three image capture devices.

9. The inspection method according to claim 6, wherein the inspection images, captured by the three image capture devices at the same time, cover one of dimensions of the to-be-inspected circuit board.

10. The inspection method according to claim 6, wherein the three fixing plates are fixed on the fixing frame uniformly.
